(19) United States
(12) Patent Application Publication
(10) Pub. No.: US 2009/0152358 A1
(43) Pub. Date: Jun. 18, 2009

(54) System and Method for a Barcode Reading Functionality Using an Image Capturing Device

(76) Inventors: Alan J. EPSHTEYN, Miller Place, NY (US); Bruno Vande Vyvre, Westhampton, NY (US); Kevin Cordes, Miller Place, NY (US); David S. Koch, Islip, NY (US); Gary Still, Plainview, NY (US)

Correspondence Address: Fay Kaplun & Marcin, LLP/ Motorola, 150 Broadway Suite 702, New York, NY, 10038, US

(21) Appl. No.: 11/956,926

(22) Filed: Dec. 14, 2007

(51) Int. Cl. G06K 7/10

(52) U.S. Cl. 235/462.2

(57) ABSTRACT

A device and method decodes data from a target. The method comprises projecting an aiming pattern onto the target using an aiming system. The aiming pattern has a predetermined shape. The method comprises capturing an image of an area using an image capturing device. The area includes at least one of a first area and a second area. The first area is an area of the aiming pattern. The second area is a predetermined area around the aiming pattern. The method comprises processing the image to determine a presence of the target within the image.

### FIELD OF THE INVENTION

The present invention relates generally to a system and method for a barcode reading functionality using an image capturing device. Specifically, a program interprets an image captured by the image capturing device to decode a barcode.

### BACKGROUND

A mobile unit (MU) may be equipped with various kinds of components. The MU may also be configured to execute a particular functionality. The components that the MU is equipped with may be tailored specifically for the particular functionality. For example, the MU may be a barcode scanner. As a barcode scanner, the MU may include a scanning engine, a laser emitter, etc. so that the MU may capture a barcode for decoding. Because the components of the MU are tailored for barcode scanning, the components may not perform other functionalities at an optimal performance level.

The MU may also include an image capturing device such as a camera. As a camera, the MU may capture an image or a plurality of images forming a video stream. Because the camera includes a basic aspect of capturing an image, the camera may be used for a barcode scanning functionality. However, neither the MU nor the camera is equipped with an intuitive aiming system that is readily available with MUs that are tailored for barcode scanning (e.g., laser emitter). Therefore, a user may have to randomly capture an image and hope that the barcode was captured for processing. Even when an aiming system such as a light generated from an LED is provided, the barcode is not necessarily captured. Furthermore, due to the high resolution of cameras and increased processing needs, even when the barcode is properly captured, decoding the barcode may take an increased amount of time, require additional resources, use more energy from a battery, etc.

### SUMMARY OF THE INVENTION

The present invention relates to a device and method for decoding data from a target. The method comprises projecting an aiming pattern onto the target using an aiming system. The aiming pattern has a predetermined shape. The method comprises capturing an image of an area using an image capturing device. The area includes at least one of a first area and a second area. The first area is an area of the aiming pattern. The second area is a predetermined area around the aiming pattern. The method comprises processing the image to determine a presence of the target within the image.

### DESCRIPTION OF THE DRAWINGS

FIG. 1 shows a mobile unit according to an exemplary embodiment of the present invention.

FIG. 2 shows a barcode with an aiming pattern from an aiming system according to an exemplary embodiment of the present invention.

FIG. 3 shows a method for a barcode reading functionality using an image capturing device according to an exemplary embodiment of the present invention.

### DETAILED DESCRIPTION

The exemplary embodiments of the present invention may be further understood with reference to the following description and the appended drawings, wherein like elements are referred to with the same reference numerals. The exemplary embodiments of the present invention describe a mobile unit (MU) equipped with a data acquisition device so that a barcode scanning functionality may be executed. Specifically, the data acquisition device may be an image capturing device. Furthermore, the exemplary embodiments of the present invention utilize an aiming system to optimize the barcode scanning functionality by narrowing a field of search within the image. According to the exemplary embodiments of the present invention, the image capturing device and a program may use the aiming system to detect an aiming pattern projected on the barcode. The MU, the image capturing device, the aiming system, and the barcode scanning functionality will be discussed in more detail below.

It should be noted that the following description of the exemplary embodiments illustrates a camera for the image capturing device. However, the camera may represent any type of image capturing device that is not specifically designed and tailored for a barcode scanning functionality. In addition, it should be noted that the following description of the exemplary embodiments illustrates an MU. However, the exemplary embodiments of the present invention may be applied to any computing device, whether mobile or not. Furthermore, it should be noted that the MU including the image capturing device is only exemplary. The MU may not be equipped with the image capturing device and, thus, the image capturing device may be coupled with the MU. For example, the image capturing device may be a module that is coupled externally to the MU (e.g., as an accessory). Finally, it should be noted that the use of barcodes is only exemplary. The barcode scanning functionality may represent any scanning functionality. Thus, the exemplary embodiments of the present invention may relate to scanning any form of image such as a one-dimensional barcode, a two-dimensional barcode, a color barcode, an optical character recognition (OCR) string, etc.

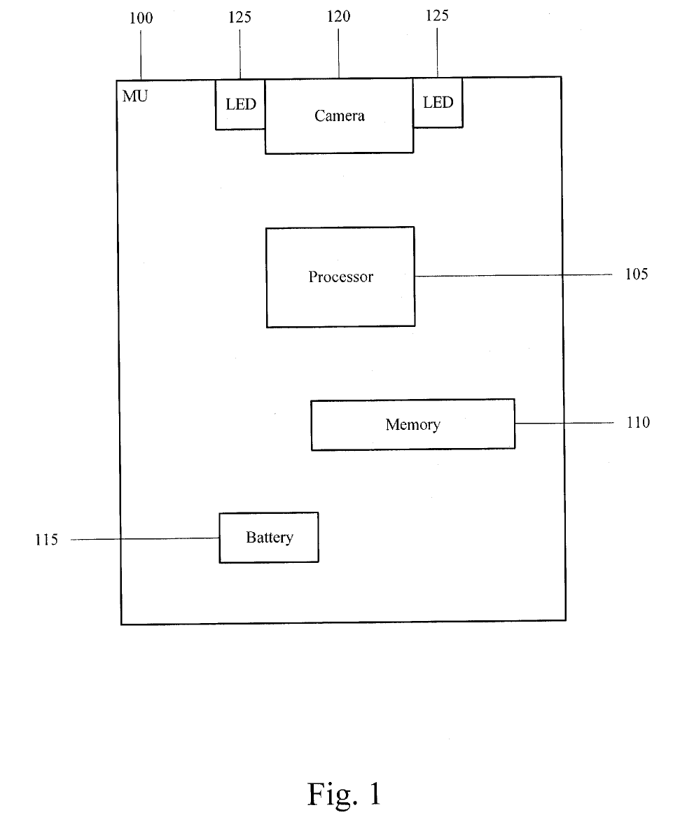

FIG. 1 shows a mobile unit (MU) 100 according to an exemplary embodiment of the present invention. The MU 100 may be any electronic device (e.g., portable or stationary) that utilizes a portable power supply (e.g., battery, capacitor, super capacitor, etc.). For example, the MU 100 may be a mobile computer, a personal digital assistant (PDA), a laptop, a pager, a cell phone, a radio frequency identification reader, a scanner, an image capturing device, etc. The MU 100 may include a processor 105, a memory 110, a battery 115, a camera 120, and light emitting diodes (LEDs) 125.

The processor 105 may be responsible for executing various functionalities of the MU 100. Specifically, according to the exemplary embodiments of the present invention, the processor 105 may be responsible for running a program associated with the barcode reading functionality. The memory 110 may be a storage unit for the MU 100. Specifically, the memory 110 may store the program as well as data and/or settings pertaining to various functionalities of the MU 100. As discussed above, the MU 100 may include a portable power supply. As illustrated, the MU 100 may include the battery 115 to supply the necessary energy to operate the MU 100.

The camera 120 may be an image capturing device. Specifically, the camera 120 may be a conventional digital color camera. Thus, the camera 120 may include a lens, a shutter, an image sensor, etc. Light passing through the lens may be received and subsequently converted to corresponding digital signals that are used to recreate the image. Those skilled in the art will understand that the camera 120 is capable of capturing color images of an object, a scene, etc. in a condition at a moment of the capture. The camera 120 may also enable a continuous set of images to be captured in a finite time period. That is, the camera 120 may be configured to capture streaming images or a video. Any image captured by the camera 120 (e.g., single image, set of images, etc.) may be stored on the memory 110.

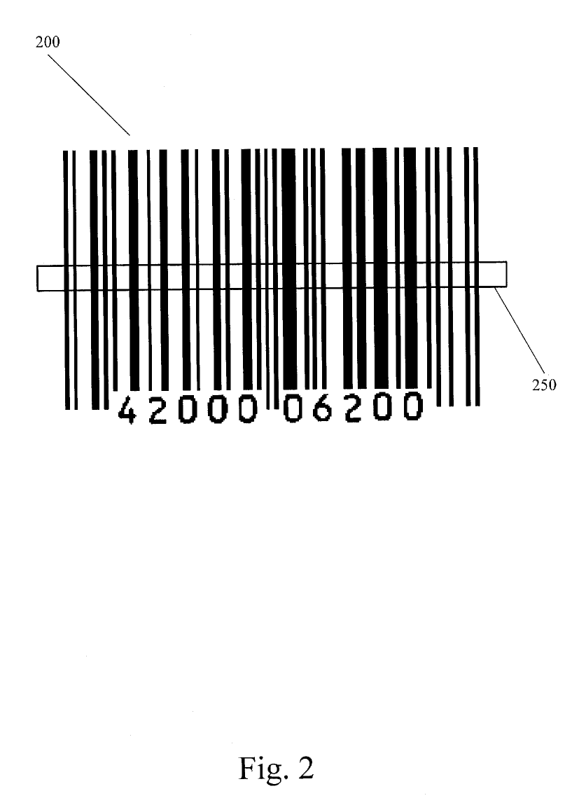

The LEDs 125 may be a light projecting device. The LEDs may represent, for example, light emitting diodes, lasers, light bulbs, etc. The LEDs 125 may be used for an aiming system of the MU 100. The LEDs 125 provide an aiming pattern that is projected on a target (e.g., barcode). The LEDs 125 may be configured so that an illumination from the LEDs 125 exhibits the aiming pattern. A filter or lens may be disposed over the LEDs 125 so that the aiming pattern is generated. The aiming pattern will be described in further detail below with reference FIG. 2. According to the exemplary embodiments of the present invention, the LEDs 125 are not required to be located on or around the camera 120. As will be discussed in further detail below, the exemplary embodiments of the present invention increase a tolerance for alignment between the aiming system and the camera 120.

The aiming system may be user intuitive so that a user may estimate the location in which to target the camera 120. As will be described in detail below, the aiming system does not require a precise optical alignment of the aiming system on the target. Through the LEDs 125, the aiming system provides a projected aiming pattern on the target (e.g., barcode). An image of at least a portion of the target may be captured. The image may be generated by the camera 120 may be used to determine whether the barcode was successfully captured in the image so that a decoding may be performed. The LEDs 125 may also include an additional LED without a filter or lens that is used to increase an illumination to an area around the target. In a first embodiment, the illumination LED may be less intense while the aiming pattern LED may be more intense. Thus, a distinction may be made. In a second embodiment, the illumination LED may be of a different color than the aiming pattern LED. Thus, a distinction may be made. In a third embodiment, the aiming pattern LED may naturally create an increased illumination.

FIG. 2 shows a barcode 200 with an aiming pattern 250 from the aiming system provided through the LEDs 125 of the MU 100 according to an exemplary embodiment of the present invention. The barcode 200 may be a conventional one-dimensional barcode. However, as discussed above, the barcode 200 may be other code forms such as two-dimensional, color, optical character recognition (OCR), etc. The aiming pattern 250 shown in FIG. 2 may be a location in which the user set the camera 120 because the aiming system is user intuitive. The aiming pattern 250 may outline an illumination provided by the LEDs 125. As illustrated, the aiming pattern 250 may be, for example, a rectangle. Because the barcode 200 is one-dimensional, a width of the rectangle may be set to a minimum as a length of the aiming pattern 250 is more pertinent for scanning the barcode 200. Thus, it should be noted that the aiming pattern 250 (including a width and a length) is only exemplary and the aiming pattern 250 may be stretched so that the aiming pattern 250 may appear to be one-dimensional.

It should be noted that the aiming pattern 250 may not appear to the user as a distinct shape. Those skilled in the art will understand that when the LEDs 125 emit a light, the light disperses or radiates from the source. The lens or filter disposed over the LEDs 125 may focus the light. However, a dispersion or radiation still occurs. Thus, the aiming pattern 250 may appear to not have distinct edges. However, a general shape may be formed such as the rectangle shape of the aiming pattern 250. The shape of the aiming pattern 250 may also be a dot, a circle, etc. Thus, the user may place the aiming pattern 250 on a substantial center of the barcode. For example, a midpoint of a median line of the barcode 200 may be used to place the aiming pattern 250. That is, the aiming pattern 250 may not extend across the entire barcode 200. It should further be noted that with a dot shape of the aiming pattern 250, a substantially distinct shape may be recognized as the dot shape may be generated with a laser that focuses the light to a greater degree.

As the aiming system is user intuitive, it may be assumed that the user will aim the camera 120 so that the aiming pattern 250 is placed on or around the barcode 200. The shape of the aiming pattern 250 may determine how a determination is made to locate and decode the barcode 200. For example, with a rectangular shape of the aiming pattern 250, an area above and below the aiming pattern 250 as well as an area within the aiming pattern 250 may be used to determine a location of the barcode. In another example, with a dot shape of the aiming pattern 250, an area extending in all directions may be used. In particular, a predetermined distance above and below the aiming pattern 250 as well as a predetermined distance left and right of the aiming pattern 250 may be used. The distance left and right of the aiming pattern 250 may be greater than the distance above and below the aiming pattern 250 as the barcode 200 extends greater in a longitudinal direction than a lateral direction.

As discussed above, the MU 100 may have a program installed thereon (i.e., stored in the memory 110 and executed by the processor 105) for the barcode reading functionality. The program may be specifically designed for reading barcodes (e.g., barcode 200) using the camera 120. Also, as discussed above, the camera 120 is capable of capturing image(s) that are processed by the processor 105. The program may be designed so that images may be processed in or near real time.

Prior to use of the barcode reading functionality, the camera 120 and/or the MU 100 may be calibrated with the aiming pattern 250. Specifically, a location of the aiming pattern 250 with respect to a captured image may be used as calibration data. For example, during a manufacturing phase, a startup phase, etc., the program may be aware of the location of the aiming pattern 250 with images to be captured by the camera 120. Depending on the shape of the aiming pattern 250, the program may determine an area to search to locate the barcode 200 to subsequently decode the barcode 200. It should be noted that the calibration of the camera 120 and/or the MU 100 may be done at other stages of use. For example, if the MU 100 and/or the camera 120 undergoes a shock event (e.g., drop, hit, etc.), the aiming pattern 250 may be generated at a different location on the image to be captured. The user may execute a calibration sequence that determines the location of the aiming pattern 250 with respect to a captured image. The program may determine whether a calibration sequence is necessary if images are captured and the barcode 200 is not located. For example, if the user places the aiming pattern 250 over the barcode 200 and the program is calibrated to understand that the aiming pattern 250 is in a different location with respect to the image, the barcode 200 may not be located by the program. Subsequent images may also lead to a similar conclusion. The program may determine that a calibration is required.

As discussed above, the aiming pattern 250 may be a basis to determine the location of the barcode 200. The camera 120 and the program may be configured to detect the aiming pattern 250 projected on the target (e.g., barcode 200). The program may subsequently process the images captured by the camera 120 to be in or around an area defined by the aiming pattern 250. As a result, a video frame rate (when the camera 120 takes streaming images) may be increased as less data is required to be processed. Accordingly, a decoding performance may be increased.

The program being capable of detecting the aiming pattern 250 may also increase a tolerance for alignment between the aiming pattern 250 and the camera 120. Specifically, the aiming pattern 250 is not required to be in perfect alignment with an axis of the camera 120. The calibration stage of the aiming pattern 250 enables such a tolerance. Furthermore, with the aiming system being user intuitive, the program detecting the position of the aiming pattern 250 in the image further allows the aiming pattern 250 to not be required to be in an ideal location so that the barcode 200 may be properly scanned. In addition, the tolerance for alignment enables a lower production cost as additional testing and precise manufacturing equipment are eliminated.

It should be noted that the camera 120 may include an automatic focusing functionality. In such an exemplary embodiment, the tolerance for the aiming system is further increased as the camera 120 is not required to be set at an ideal distance from the target. The lens of the camera 120 may adjust accordingly so that an image of the barcode 200 is clearly captured. With respect to the automatic focusing functionality, even after a calibration, there may still be a parallax between the camera 120 and an axis of the aiming pattern 250. That is, a location of the aiming pattern 250 disposed on the image may change when the target (e.g., barcode 200) is placed at different distances from the camera 120. The program may include an algorithm or database of values to determine a location of the aiming pattern 250 on the image as a function of a focus setting. The algorithm may be determined during the calibration phase. However, it should also be noted that the camera 120 may also be a fixed focus camera. In such an embodiment, the aiming system may provide a predetermined distance for the camera 120 to be set so that an image of the barcode 200 is clearly captured.

Furthermore, it should noted that the processor 105 of the MU 100 executing the program, processing the images captured by the camera 120, etc. are only exemplary. As discussed above, the camera 120 may be a module and the MU 100 may be coupled to another device such as server. That is, the MU 100 may be equipped with connectivity devices such as a transceiver to exchange data with another electronic device. A processor disposed in the other device may receive and process data relating to the barcode functionality.

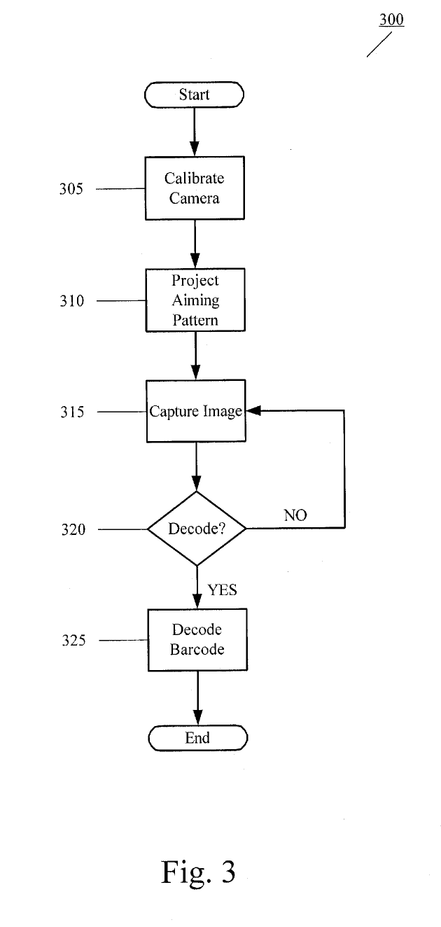

FIG. 3 shows a method 300 for a barcode reading functionality using an image capturing device according to an exemplary embodiment of the present invention. The method 300 will be described with reference to the components of the MU 100 of FIG. 1, the barcode 200 of FIG. 2, and the aiming pattern 250 of FIG. 2. It should be noted that prior to execution of the method 300, it may be assumed that the camera 120 and the LEDs 125 are activated. It may also be assumed that the user places the aiming pattern 250 on or around the target (e.g., barcode 200) as the aiming system is user intuitive.

In step 305, the camera 120 is calibrated. As discussed above, the camera 120 and/or the MU 100 may be calibrated so that the program is aware of a position of the aiming pattern 250 relative to a captured image. The calibration may also increase the tolerance between the camera 120 and the aiming system as a perfect alignment is not required. Furthermore, as discussed above, the calibration of the camera 120 and/or the MU 100 may be done at different times. The calibration may be done during a manufacturing phase so that the user is not required to perform this step. The calibration may be done at a startup of the MU 100. The calibration may also be done when the MU 100 and/or the camera 120 undergoes a shock event. The calibration may also be a routine process performed at regular intervals so that the position of the aiming pattern 250 relative to the image is always known. The program may offer a reminder to the user at predetermined times.

In step 310, the aiming pattern 250 is projected. As discussed above, the LEDs 125 may project the aiming pattern onto the target. Because the aiming system is user intuitive, the user may align the aiming system to project the aiming pattern. In addition, because the aiming system is user intuitive, the barcode scanning functionality program enables a greater range for a proper alignment of the aiming system.

In step 315, an image is captured using the camera 120. The image captured in step 315 may be used to determine whether the barcode 200 is present (i.e., determine a location of the barcode 200). It should be noted that the image captured in step 315 may be a frame of streaming images (i.e., video) captured by the camera 120.

In step 320, a determination is made whether the image has appropriately embodied the target. The determination indicates whether the intended target has been captured. That is, a verification is performed in predetermined search areas on and around the aiming pattern 250 to locate the barcode 200. For example, the determination may indicate that an entire barcode (i.e., intended target) is within the captured image. The camera 120 and the program installed on the MU 100 may use the aiming pattern as a starting point in which to make the determination.

If step 320 determines that the barcode 200 is not located in the image, the method 300 returns to step 315 where another image is taken. In this respect, images are continuously captured until the target has been properly embodied to determine the location of the barcode 200 so that a decoding of the barcode 200 may be performed. For example, a first frame or image captured may not be in focus when captured that a determination of locating the barcode 200 results negatively. Subsequent images may properly focus the image so that the location of the barcode 200 is ascertained on or around the aiming pattern 250. Again, it should be noted that the continuous capturing of images may be frames of streaming images in a video. In step 325, when the program has successfully identified the barcode 200 within the captured image, the barcode 200 is decoded.

Those skilled in the art will understand that the above described exemplary embodiments may be implemented in any number of manners, including, as a separate software module, as a combination of hardware and software, etc. For example, the barcode scanning functionality program may contain lines of code that, when compiled, are executed on the processor 105.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A method for decoding data from a target, comprising:
projecting an aiming pattern onto the target using an aiming system, the aiming pattern having a predetermined shape;
capturing an image of an area using an image capturing device, the area including at least one of a first area and a second area, the first area being an area of the aiming pattern, the second area being a predetermined area around the aiming pattern; and
processing the image to determine a presence of the target within the image.

2. The method of claim 1, further comprising:
decoding the target when the target is determined to be present within the image.

3. The method of claim 1, further comprising:
capturing at least one further image of the area until the presence of the target within the at least one further image is determined from processing the at least one further image.

4. The method of claim 1, wherein the target is one of a one-dimensional barcode, a two-dimensional barcode, a color barcode, and an optical character recognition string.

5. The method of claim 1, wherein the aiming pattern is produced from at least one light emitting diode (LED).

6. The method of claim 5, wherein the shape of the aiming pattern is generated using one of a filter and a lens disposed over the at least one LED.

7. The method of claim 1, wherein the image capturing device detects the aiming pattern projected on the target.

8. The method of claim 7, wherein the detecting increases a tolerance for alignment between the aiming system and the image capturing device.

9. The method of claim 7, further comprising:
calibrating the image capturing device so that the image capturing device is aware of a position of the aiming pattern relative to the image.

10. The method of claim 9, wherein the calibrating is performed at least one of during a manufacturing phase, prior to a first use of the image capturing device, and after a first use of the image capturing device.

11. A mobile unit, comprising:
an aiming arrangement projecting an aiming pattern onto a target, the aiming pattern having a predetermined shape; and
an image capturing device capturing an image of an area, the area including at least one of a first area and a second area, the first area being an area of the aiming pattern, the second area being a predetermined area around the aiming pattern, the image being processed to determine a presence of the target within the image.

12. The mobile unit of claim 11, wherein the target is decoded when the target is determined to be present within the image.

13. The mobile unit of claim 11, wherein the image capturing device captures at least one further image of the area until the presence of the target within the at least one further image is determined from processing the at least one further image.

14. The mobile unit of claim 11, wherein the target is one of a one-dimensional barcode, a two-dimensional barcode, a color barcode, and an optical character recognition string.

15. The mobile unit of claim 11, further comprising:
at least one light emitting diode (LED) producing the aiming pattern.

16. The mobile unit of claim 15, further comprising:
one of a filter and a lens disposed over the at least one LED to generate the shape of the aiming pattern.

17. The mobile unit of claim 11, wherein the image capturing device detects the aiming pattern projected on the target.

18. The mobile unit of claim 17, wherein the detecting increases a tolerance for alignment between the aiming system and the image capturing device.

19. The mobile unit of claim 17, wherein the image capturing device is calibrated so that the image capturing device is aware of a position of the aiming pattern relative to the image.

20. The mobile unit of claim 19, the calibrating is performed at least one of during a manufacturing phase, prior to a first use of the image capturing device, and after a first use of the image capturing device.

21. A computer readable storage medium including a set of instructions executable by a processor, the set of instructions for decoding data from a target operable to:
project an aiming pattern onto the target using an aiming system, the aiming pattern having a predetermined shape;
capture an image of an area using an image capturing device, the area including at least one of a first area and a second area, the first area being an area of the aiming pattern, the second area being a predetermined area around the aiming pattern; and
process the image to determine a presence of the target within the image.

22. A mobile unit, comprising:
an aiming means for projecting an aiming pattern onto a target, the aiming pattern having a predetermined shape; and
an image capturing means for capturing an image of an area, the area including at least one of a first area and a second area, the first area being an area of the aiming pattern, the second area being a predetermined area around the aiming pattern, the image being processed to determine a presence of the target within the image.
